(19) United States
(12) Patent Application Publication
(10) Pub. No.: US 2026/0094053 A1
(43) Pub. Date: Apr. 2, 2026

(54) COMPUTER SYSTEMS AND METHODS FOR FEATURE SELECTION FOR MACHINE-LEARNING MODELS

(71) Applicant: Capital One Financial Corporation, McLean, VA (US)

(72) Inventors: Shay Deutsch, Los Angeles, CA (US); Arjun Ravi Kannan, Buffalo Grove, IL (US); Alex Lin, San Francisco, CA (US); Lionel Yelibi, Houston, TX (US)

(21) Appl. No.: 18/901,710

(22) Filed: Sep. 30, 2024

(51) Int. Cl. G06N 20/00

(52) U.S. Cl. CPC G06N 20/00

(57) ABSTRACT

A computing platform may be configured to: (i) identify an initial set of features; (ii) obtain an input dataset comprising a set of data records that each includes respective values for the initial set of features; (iii) build a feature graph based on the input dataset; (iv) determine a reduced set of features from the initial set of features by selecting features for inclusion in the reduced set of features based on a balancing between (a) diffusion size of features within the feature graph and (b) diffusion overlap of features within the feature graph relative to any features that were selected for inclusion in the reduced set of features; and (v) utilize the reduced set of features in a machine-learning process for training a machine-learning model.

### BACKGROUND

Organizations in many different industries have begun to operate computing platforms that are configured to ingest, process, analyze, generate, store, and/or output data that is relevant to the businesses of those organizations. Such computing platforms are often referred to as “data platforms.” For example, a financial institution may operate a data platform that is configured to ingest, process, analyze, generate, store, and/or output data related to the financial institution's customers and their financial accounts, such as financial transactions data (among other types of data that may be relevant to the financial institution's business). As another example, an organization interested in monitoring the state and/or operation of physical objects such as industrial machines, transport vehicles, and/or other Internet-of-Things (IoT) devices may operate a data platform that is configured to ingest, process, analyze, generate, store, and/or output data related to those physical objects of interest. As another example, a provider of a Software-as-a-Service (SaaS) application may operate a data platform that is configured to ingest, process, analyze, generate, store, and/or output data that is created in connection with that SaaS application. Many other examples are possible as well.

Data platforms such as these may provide several benefits to organizations, including but not limited to enabling organizations to achieve efficiencies in data management and analysis and enabling organizations to unlock the value of their data in ways not previously possible, which may lead to more informed business decisions and new business opportunities. Data platforms may provide various other advantages as well.

### OVERVIEW

In one aspect, the disclosed technology may take the form of a computer-implemented method carried out by a computing platform that involves: (i) identifying an initial set of features; (ii) obtaining an input dataset comprising a set of data records that each includes respective values for the initial set of features; (iii) building a feature graph based on the input dataset, wherein the feature graph comprises (a) nodes that represent the features of initial set of features and (b) connections that represent similarities between the features of the initial set of features; (iv) determining a reduced set of features from the initial set of features by selecting features for inclusion in the reduced set of features based on a balancing between (a) diffusion size of features within the feature graph and (b) diffusion overlap of features within the feature graph relative to any features that were selected for inclusion in the reduced set of features; and (v) utilizing the reduced set of features in a machine-learning process for training a machine-learning model.

In an example, selecting features for inclusion in the reduced set of features based on the balancing between (i) diffusion size of features within the feature graph and (ii) diffusion overlap of features within the feature graph relative to any features that were selected for inclusion in the reduced set of features comprises: performing a plurality of iterations of a sampling process, wherein each iteration comprises: (i) defining a subset of features from the features of the feature graph to utilize for the iteration; (ii) obtaining, for each respective feature in the subset, a measure of the respective feature's diffusion size; (iii) obtaining, for each respective feature in the subset, a measure of the respective feature's diffusion overlap relative to any previously-selected features that were selected for inclusion in the reduced set of features; (iv) selecting, based on the obtained measures of diffusion size and the obtained measures of diffusion overlap, whichever feature from the subset that strikes a most-optimal balance between diffusion size and diffusion overlap; and (v) adding the selected feature to the reduced set of features.

In an example, obtaining, for each respective feature in the subset, the measure of the respective feature's diffusion size comprises: determining the measure of the respective feature's diffusion size by (i) applying a localization operator to the respective feature, which produces a respective localization vector for the feature, and (ii) calculating a norm of the feature's respective localization vector.

In an example, obtaining, for each respective feature in the subset, the measure of the respective feature's diffusion overlap relative to any previously-selected features that were selected for inclusion in the reduced set of features comprises: for each respective previously-selected feature, determining the measure of the respective feature's diffusion overlap relative to the respective previously-selected feature by (i) applying a localization operator to the respective feature as well as the respective previously-selected feature, which produces respective localization vectors for the respective feature and the respective previously-selected feature, and (ii) calculating an overlap value between the respective localization vectors.

In an example, selecting, based on the obtained measures of diffusion size and the obtained measures of diffusion overlap, whichever feature from the subset that strikes a most-optimal balance between diffusion size and diffusion overlap comprises: optimizing an objective function using a greedy technique, wherein the objective function defines an optimal feature to be selected based on any previously-selected features that were selected for inclusion in the reduced set of features.

In an example, a number of the plurality of iterations is a predefined percentage of total number of nodes in the feature graph.

In an example, building the feature graph based on the input dataset comprises: (i) computing a correlation matrix based on the input dataset; and (ii) constructing the feature graph using the computed correlation matrix.

In an example, the machine-learning model comprises a clustering-based model that is trained using one or more unsupervised learning techniques.

In another aspect, disclosed herein is a computing platform that includes at least one network interface, at least one processor, at least one non-transitory computer-readable medium, and program instructions stored on the at least one non-transitory computer-readable medium that, when executed by the at least one processor, cause the computing platform to carry out the functions disclosed herein, including but not limited to the functions of the foregoing method.

For instance, in an example, a computing platform comprises: a communication interface; at least one processor; at least one non-transitory computer-readable medium; and program instructions stored on the at least one non-transitory computer-readable medium that, when executed by the at least one processor, cause the computing platform to: (i) identify an initial set of features; (ii) obtain an input dataset comprising a set of data records that each includes respective values for the initial set of features; (iii) build a feature graph based on the input dataset, wherein the feature graph comprises (a) nodes that represent the features of initial set of features and (b) connections that represent similarities between the features of the initial set of features; (iv) determine a reduced set of features from the initial set of features by selecting features for inclusion in the reduced set of features based on a balancing between (a) diffusion size of features within the feature graph and (b) diffusion overlap of features within the feature graph relative to any features that were selected for inclusion in the reduced set of features; and (v) utilize the reduced set of features in a machine-learning process for training a machine-learning model.

In an example, selecting features for inclusion in the reduced set of features based on the balancing between (i) diffusion size of features within the feature graph and (ii) diffusion overlap of features within the feature graph relative to any features that were selected for inclusion in the reduced set of features comprises: performing a plurality of iterations of a sampling process, wherein each iteration comprises: (i) defining a subset of features from the features of the feature graph to utilize for the iteration; (ii) obtaining, for each respective feature in the subset, a measure of the respective feature's diffusion size; (iii) obtaining, for each respective feature in the subset, a measure of the respective feature's diffusion overlap relative to any previously-selected features that were selected for inclusion in the reduced set of features; (iv) selecting, based on the obtained measures of diffusion size and the obtained measures of diffusion overlap, whichever feature from the subset that strikes a most-optimal balance between diffusion size and diffusion overlap; and (v) adding the selected feature to the reduced set of features.

In an example, obtaining, for each respective feature in the subset, the measure of the respective feature's diffusion size comprises: determining the measure of the respective feature's diffusion size by (i) applying a localization operator to the respective feature, which produces a respective localization vector for the feature, and (ii) calculating a norm of the feature's respective localization vector.

In an example, obtaining, for each respective feature in the subset, the measure of the respective feature's diffusion overlap relative to any previously-selected features that were selected for inclusion in the reduced set of features comprises: for each respective previously-selected feature, determining the measure of the respective feature's diffusion overlap relative to the respective previously-selected feature by (i) applying a localization operator to the respective feature as well as the respective previously-selected feature, which produces respective localization vectors for the respective feature and the respective previously-selected feature, and (ii) calculating an overlap value between the respective localization vectors.

In an example, selecting, based on the obtained measures of diffusion size and the obtained measures of diffusion overlap, whichever feature from the subset that strikes a most-optimal balance between diffusion size and diffusion overlap comprises: optimizing an objective function using a greedy technique, wherein the objective function defines an optimal feature to be selected based on any previously-selected features that were selected for inclusion in the reduced set of features.

In an example, a number of the plurality of iterations is a predefined percentage of total number of nodes in the feature graph.

In an example, the program instructions stored on the at least one non-transitory computer-readable medium that, when executed by the at least one processor, cause the computing platform to build the feature graph based on the input dataset comprise program instructions stored on the at least one non-transitory computer-readable medium that, when executed by the at least one processor, cause the computing platform to: (i) compute a correlation matrix based on the input dataset; and (ii) construct the feature graph using the computed correlation matrix.

In an example, the machine-learning model comprises a clustering-based model that is trained using one or more unsupervised learning techniques.

In yet another aspect, disclosed herein is a non-transitory computer-readable medium comprising program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network environment in which aspects of the disclosed technology may be implemented.

FIG. 2 depicts a flow diagram of an example process for reducing sets of features and utilizing reduced sets of features for training machine-learning models, according to aspects of the disclosed technology.

FIG. 3 illustrates a visualization of an example feature graph, according to aspects of the disclosed technology.

FIG. 4 depicts a flow diagram of an example process for an example iteration of the disclosed sampling approach, according to aspects of the disclosed technology.

FIG. 5A depicts a visual representation of an example feature graph and an example reduced set of features determined by applying the disclosed sampling approach, according to aspects of the disclosed technology.

FIG. 5B depicts a visual representation of an example feature graph and an example reduced set of features determined by applying a betweenness-centrality approach.

FIG. 6A illustrates a visualization of an example dataset.

FIG. 6B illustrates a visualization of the example dataset with ground truth labels.

FIG. 6C illustrates a visualization of example clustering results based on a full set of features, according to an example.

FIG. 6D illustrates a visualization of example clustering results based on a reduced set of features determined by applying the disclosed sampling approach, according to aspects of the disclosed technology.

FIG. 7 is a simplified block diagram that illustrates some structural components of an example computing platform.

FIG. 8 is a simplified block diagram that illustrates some structural components of an example consumer system.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, organizations in many different industries have begun to operate computing platforms that are configured to ingest, process, analyze, generate, store, and/or output data that is relevant to the businesses of those organizations, which are often referred to as “data platforms.” For example, a financial institution may operate a data platform that is configured to ingest, process, analyze, generate, store, and/or output data related to the financial institution's customers and their financial accounts, such as financial transactions data (among other types of data that may be relevant to the financial institution's business). As another example, an organization interested in monitoring the state and/or operation of physical objects such as industrial machines, transport vehicles, and/or other Internet-of-Things (IoT) devices may operate a data platform that is configured to ingest, process, analyze, generate, store, and/or output data related to those physical objects of interest. As another example, a provider of a Software-as-a-Service (SaaS) application (e.g., a social media application) may operate a data platform that is configured to ingest, process, analyze, generate, store, and/or output data that is created in connection with that SaaS application. Many other examples are possible as well.

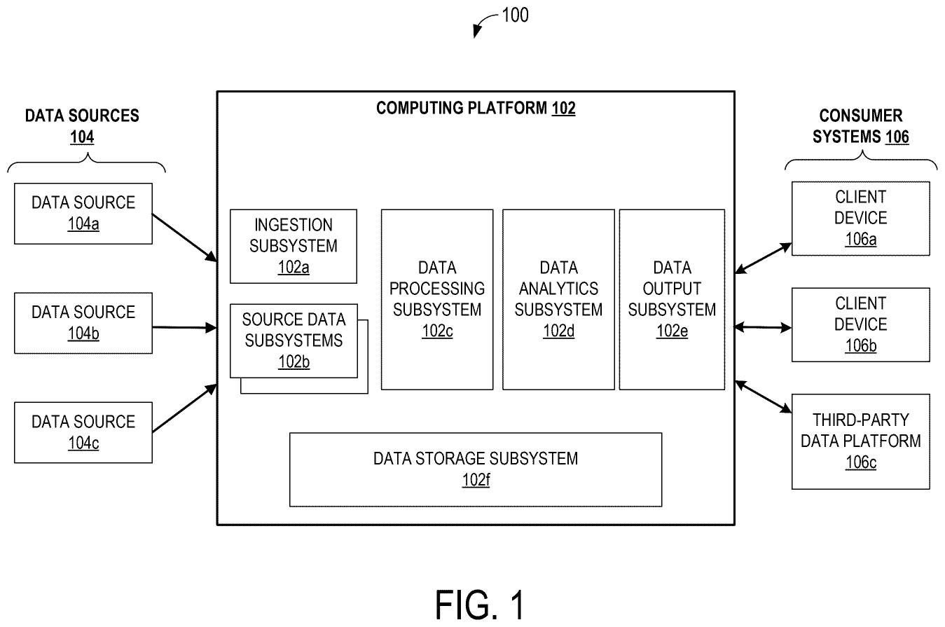

To illustrate with an example, FIG. 1 depicts a network environment 100 that includes at its core an example computing platform 102 that serves as a data platform for an organization, which may comprise a collection of functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of organization operating the example computing platform 102. For example, if the example computing platform 102 comprises a data platform operated by a financial institution, the data sources 104 may comprise computing devices and/or systems that generate and output data related to the financial institution's customers and their financial accounts, such as financial transactions data (e.g., purchase and/or sales data, payments data, etc.), customer identification data (e.g., name, address, social security number, etc.), customer interaction data (e.g., web-based interactions with the financial institution such as logins, as well as call logs, chat logs, and/or complaints), and/or credit history data, among various other possibilities. In this respect, the data sources that generate and output such data may take the form of payment processors, merchant service provider systems such as payment gateways, point-of-sale (POS) terminals, automated teller machines (ATMs), computing systems at brick-and-mortar branches of the financial institution, and/or client devices of customers (e.g., personal computers, mobile phones, tablets, etc.), among various other possibilities. The data sources 104 may take various other forms as well.

Further, as shown in FIG. 1, the example computing platform 102 may comprise one or more source data subsystems 102b that are configured to internally generate and output source data that is consumed by the example computing platform 102. These source data subsystems 102b may take any of various forms, which may depend at least in part on the type of organization operating the example computing platform 102. For example, if the example computing platform 102 comprises a data platform operated by a financial institution, the one or more source data subsystems 102b may comprise functional subsystems that internally generate and output certain types of data related to customer accounts (e.g., account balance data, payment schedule data, etc.). The one or more source data subsystems 102b may take various other forms as well.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of organization operating the example computing platform 102. For example, if the example computing platform 102 comprises a data platform operated by a financial institution, the data analytics subsystem 102d may be configured to carry out data analytics operations in order to derive certain types of insights that are relevant to the financial institution's business, examples of which could include predictions of fraud, money laundering, or other suspicious activity on a customer's account, and/or predictions of whether to extend credit to an existing or prospective customer, among other possibilities. The data analytics subsystem 102d may be configured to carry out any of numerous other types of data analytics operations as well.

Moreover, the data analytics operations carried out by the data analytics subsystem 102d may be embodied in any of various forms. As one possibility, a data analytics operation may be embodied in the form of a user-defined rule (or set of rules) that is applied to a particular subset of the processed data in order to derive insights from that processed data. As another possibility, a data analytics operation may be embodied in the form of a data science model that is applied to a particular subset of the processed data in order to derive insights from that processed data. In practice, such a data science model may comprise a machine-learning model that has been created by applying one or more machine-learning techniques to a set of training data, but data science models for performing data analytics operations could take other forms and be created in other manners as well. The data analytics operations carried out by the data analytics subsystem 102d may be embodied in other forms as well.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the organization (e.g., employees, contractors, etc.) and/or individuals seeking to obtain goods and/or services from the organization. As another possibility, the data output subsystem 102e may be configured to output certain data to other third-party platforms, such as the representative third-party platform 106c shown in FIG. 1.

In order to facilitate this functionality for outputting data to the consumer systems 106, the data output subsystem 102e may comprise one or more Application Programming Interface (APIs) that can be used to interact with and output certain data to the consumer systems 106 over a data network, and perhaps also an application service subsystem that is configured to drive the software applications running on the client devices, among other possibilities.

The data output subsystem 102e may be configured to output data to other types of consumer systems 106 as well.

Referring once more to FIG. 1, the example computing platform 102 may also comprise a data storage subsystem 102f that is configured to store all of the different data within the example computing platform 102, including but not limited to the source data, the processed data, and the derived insights. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, etc.) that are utilized to implement the functional subsystems discussed herein. This set of physical computing resources take any of various forms. As one possibility, the computing platform 102 may comprise computing infrastructure of a public, private, and/or hybrid cloud (e.g., computing and/or storage clusters). In this respect, the organization that operates the example computing platform 102 may either supply its own cloud infrastructure or may obtain the cloud infrastructure from a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise one or more servers that are owned and operated by the organization that operates the example computing platform 102. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

As noted above, the example computing platform 102 may be configured to interact with the data sources 104 and consumer systems 106 over respective communication paths. Each of these communication paths may generally comprise one or more data networks and/or data links, which may take any of various forms. For instance, each respective communication path with the example computing platform 102 may include any one or more of point-to-point data links, Personal Area Networks (PANs), Local Area Networks (LANs), Wide Area Networks (WANs) such as the Internet or cellular networks, and/or cloud networks, among other possibilities. Further, the data networks and/or links that make up each respective communication path may be wireless, wired, or some combination thereof, and may carry data according to any of various different communication protocols. Although not shown, the respective communication paths may also include one or more intermediate systems, examples of which may include a data aggregation system and host server, among other possibilities. Many other configurations are also possible.

It should be understood that the network environment 100 is one example of a network environment in which a data platform may be operated, and that numerous other examples of network environments, data platforms, data sources, and consumer systems are possible as well.

Returning to data analytics subsystem 102d of FIG. 1, in some implementations, data analytics subsystem 102d may train, retrain, and/or execute various different types of machine-learning models (e.g., in order to obtain insights for the organization associated with the computing platform 102).

In general, such a machine-learning model may be configured to (i) receive values for a set of input variables that are commonly referred to as “features” and then (ii) output a prediction based on an evaluation of the received values. Machine-learning models such as these may be used in industry for any of various tasks, which may depend at least in part on the type of organization operating the example computing platform 102. For instance, if the example computing platform 102 comprises a data platform operated by a financial institution, a financial institution may utilize a machine-learning model to render and output any of various types of predictions related to the financial institution's business, which may include a prediction of whether a transaction is a fraudulent transaction, a prediction of whether a customer or merchant is engaged in money laundering activities, a prediction of whether a customer committed fraud on a credit card application, or a prediction of whether a prospective or current customer is qualified to receive credit, among various other possibilities. As another example, if the example computing platform 102 comprises a data platform operated by an organization interested in monitoring the state and/or operation of physical objects, the organization may utilize a machine-learning model to render and output any of various types of predictions related to the physical objects, which may include a prediction of whether a maintenance and/or repair of the object may be required, among various other possibilities.

As will be appreciated, the features that define the inputs to a machine-learning model play a significant role in the predictions that are rendered by the machine-learning model. Indeed, depending on which set of features are selected, a given machine-learning model's prediction accuracy could widely vary.

A machine-learning model of the type described above is typically created through a multi-stage process that may involve (i) selecting an initial set of features that could potentially have predictive value for a given type of prediction to be made by the machine-learning model, (ii) obtaining training data for the machine-learning model, which comprises a set of training data records that each includes respective values for the initial set of features, (iii) applying a machine-learning process (e.g., a process involving supervised, semi-supervised, and/or unsupervised learning techniques) to the training data one or more times in order to train one or more instances of the machine-learning model (sometimes referred to as a “model objects”) that each functions to (a) receive values for at least a subset of the initial set of features as input and (b) output a prediction of the given type, and (iv) validating the one or more instances of the machine-learning model (which may involve selecting the instance of the machine-learning model having the best performance), among other possible stages of the multi-stage process for creating a machine-learning model.

In practice, the number of features that may be selected initially (i.e., the universe of features that could potentially have predictive value) could be in the many hundreds or even the thousands. For instance, if a machine-learning model is being created for purposes of rendering a prediction of whether a transaction is fraudulent or whether an individual is qualified to receive credit, the universe of features that could potentially have predictive value to that type of prediction could be in the many hundreds or even the thousands However, applying a machine-learning process to training data comprising values for a larger, unfiltered set of features presents various problems.

One example problem is that applying a machine-learning process to training data comprising values for a larger, unfiltered set may degrade the accuracy of the machine-learning model that is trained by the machine-learning process. This is primarily due to the fact that a larger initial set of features often includes features that introduce noise by virtue of being irrelevant, redundant, and/or correlated with one another. In the presence of many features that are irrelevant, redundant, and/or correlated, the machine-learning model that is trained by a machine-learning process may have degraded accuracy. In an example, for a machine-learning model that is trained by the machine-learning process that utilizes training data comprising values for a larger, unfiltered set, the machine-learning model's ability to generalize may be compromised, as the machine-learning model can learn patterns based on random noise.

Another example problem is that applying a machine-learning process to training data comprising values for a larger, unfiltered set of features requires a significant amount of computational resources (e.g., processing resources) and may take a long time to complete. In this regard, more features may introduce more computing resources and delay into the machine-learning process. Thus, the more features there are in the initial set of features, the more difficult it typically is to train a machine-learning model.

Yet another example problem is that applying a machine-learning process to training data comprising values for a larger, unfiltered set of features may suffer from what is known as the curse of dimensionality. As used herein, the “curse of dimensionality” refers to various phenomena that can arise when analyzing and organizing data in high-dimensional spaces that do not occur in low-dimensional settings (such as the three-dimensional physical space of everyday experience). In an example, the curse of dimensionality may make it difficult to identify meaningful patterns and may lead to poor separation of clusters relative to their ground truth labels.

Yet another example problem is that applying a machine-learning process to training data comprising values for a larger, unfiltered set of features may degrade interpretability of an output of a machine-learning model that is trained by the machine-learning process. In this regard, the presence of many features that are irrelevant, redundant, and/or correlated can hinder interpretability of the output of the machine-learning model.

Other problems related to applying a machine-learning process to training data comprising values for a larger initial set of features are possible as well.

To overcome problems with applying a machine-learning process to training data comprising values for a larger, unfiltered set of features when training a machine-learning model, some technology has been developed for reducing an initial set of features prior to applying a machine-learning process to training data in order to train a machine-learning model.

For instance, one existing technology for reducing an initial set of features (which may also be referred to as “filtering an initial set of features”) prior to applying a machine-learning process to training data in order to train a machine-learning model involves randomly or arbitrarily removing some of the features in the initial set to get down to a smaller number of features that are utilized during the machine-learning process. However, this existing technology for reducing the initial set of features fails to perform well in producing a reduced set of features that is sufficiently representative of the intrinsic structure of an input dataset (which may comprise a set of data records that each includes respective values for the initial set of features), because randomly or arbitrarily removing some of the features does not consider the relationships between the features. Instead, the reduced set of features produced by this existing technology still includes noisy features (e.g., features that are irrelevant, redundant, and/or correlated with one another) that degrade the accuracy of the machine-learning model trained by the machine-learning process. As used herein, the “intrinsic structure of the input dataset” refers to the underlying geometric structure and the true relationship among the data points of the input dataset. The underlying geometric structure and the true relationship among the data points of the input dataset may be difficult to discover. For instance, in an example, a simple method using Euclidean measurement between data points may be misleading and wrongly indicate that points belong to a same part of the geometric structure while the points actually belong to a different part of the geometric structure (e.g., a different cluster). A machine-learning model may aim to discover the underlying geometric structure and the true relationship among the data points of the input dataset (which, e.g., for complex data cannot be discovered by simple measurement such as Euclidean distance).

Another example existing technology for reducing an initial set of features prior to applying a machine-learning process to training data in order to train a machine-learning model involves (i) constructing an observation graph using a technique such as adaptive graph construction, where the observation graph comprises nodes that each represents a respective data record containing values for the initial set of features (i.e., a multi-dimensional data point where the different dimensions correspond to the different features), and then (ii) reducing the initial set of features based on an analysis of the observation graph. However, analyzing an observation graph to reduce an initial set of features suffers from various limitations and may fail to perform well in producing a reduced set of features that is sufficiently representative of the intrinsic structure of an input dataset.

Analyzing an observation graph to reduce an initial set of features may involve feature selection utilizing supervised and/or unsupervised techniques. Turning first to observation-graph based feature selection utilizing supervised techniques, the observation-graph based feature selection utilizing supervised techniques may involve a process of selecting a subset of relevant features (input variables) that contribute the most to the prediction of the target variable in a supervised learning model. It is used to improve performance and eliminate noise (e.g., irrelevant, redundant, and/or correlated features) by leveraging the relationship between the input features and the output labels during the selection process. Typical examples for methods that perform feature selection during the machine-learning model training process are methods using Lasso (L1 Regularization), Decision Trees, and Random Forests. These methods are specific to certain machine-learning algorithms that inherently rank or select features based on their contribution to the machine-learning model. In general, the ways through which features are selected given a target are twofold: (i) the internal distance between observations of the same class; and (ii) the distance between observations of different classes. The topology of an observation graph (e.g., a graph which is constructed by mapping the observations to its node and the links weights are estimated by computing distances between observations) may be optimized by minimizing (i) the internal distance between observations of the same class and maximizing (ii) the distance between observations of different classes. This then ensures that the resulting transformed graph possesses the following characteristics: the data density of individual classes is increased as is the separation of classes. One way this may be achieved is by minimizing a Mahalanobis distance as a sort of Euclidean distance. However, observation-graph based feature selection utilizing supervised techniques suffer from various drawbacks. For instance, the feature weights can be used to reduce the initial feature set but require additional manual judgment on what threshold needs to be used. Furthermore, such techniques require ground truth labels which are often difficult to obtain and/or are unavailable.

On the other hand, in observation-graph based feature selection utilizing unsupervised techniques, the target variable is not being considered but rather only the local or global interaction of the features. When no target is provided, existing techniques may involve applying an optimization procedure that maximizes the observation-graph modularity, which is the characteristic of a dataset to have compact, dense, and separable groups. However, observation-graph based feature selection utilizing unsupervised techniques suffer from various drawbacks. For instance, modularity maximization has been shown to overfit to the observation graph, and modularity as an optimization cost function suffers from what is known as “rough landscape,” such that many high modularity solutions can have significantly different structure.

Additionally, observation-graph based feature selection techniques can be challenging in various other ways. For instance, scalability is a concern for industrial-scale datasets which may require sampling. However, existing sampling techniques may introduce bias especially in dataset with severe class imbalance. Further, non-linearities in the observation graph topology often exist. However, class separation, which may be the goal of the optimization, becomes challenging when the classes are not linearly separable. Thus, it is highly possible the result may be biased in nontrivial ways and may thus fail to properly provide guidance on feature reduction.

Yet another example existing technology for reducing an initial set features of prior to applying a machine-learning process to training data in order to train a machine-learning model involves (i) constructing a feature graph using a technique such as mutual information correlation or Pearson correlation, where the feature graph comprises nodes that each represents a respective feature from the initial set of features and edges that each represents a similarly level between two features from the initial set of features in terms of an associated numerical value or the like (e.g., on a scale from 0 to 1, where 0 means not similar and 1 means maximum level of similarity), and (ii) reducing the initial set of features based on an analysis of the feature graph. In this respect, various technologies currently exist for analyzing a feature graph to reduce an initial set of features prior to applying a machine-learning process to training data in order to train a machine-learning model.

For instance, one example technology for analyzing a feature graph to reduce an initial set of features is a “betweenness-centrality” approach. At a high level, a betweenness-centrality approach may identify a measure of importance of an edge with respect to a structure of a feature graph. More particularly, a measure of importance of an edge with respect to a structure of the feature graph may comprise an estimate of edge betweenness centrality (EBC), which may represent a fraction of shortest distance paths that pass through each edge. In this regard, edges with low EBC are often located in dense clusters of nodes in the graph structure, whereas edges with high EBC are often located in transition regions between clusters. Accordingly, an edge's EBC serves as an indicator of an edge's potential to serve as a bottleneck between clusters of nodes in a feature graph.

Another example technology for analyzing a feature graph to reduce an initial set of features is a feature learning approach that utilizes an optimization algorithm to sparsify the feature graph into a sparse graph. For example, a Topological Feature Selection (TFS) method employs model dependency structures among features using a Triangulated Maximally Filtered Graph, so as to maximize the likelihood of features' relevance by studying their relative position inside the feature graph.

However, the existing technologies for analyzing a feature graph to reduce an initial set of features often fail to perform well in producing a reduced set of features that is sufficiently representative of the intrinsic structure of an input dataset (which may comprise a set of data records that each includes respective values for the initial set of features). For instance, while a betweenness-centrality approach is typically able to identify some of the important features that may be located in transition regions between clusters, betweenness-centrality often neglects other features that may also be important. Thus, a betweenness-centrality approach may result in a reduced set of features that is not representative or not substantially representative of the intrinsic structure of the input dataset. Further, feature learning approaches that utilize an optimization algorithm to sparsify the feature graph into a sparse graph typically do not consider the intrinsic structure of the input dataset explicitly but rather focus on the correlation between the features, and as a result, such feature learning approaches may lose important information that is discarded in the process of sparsifying the feature graph.

To address these and other problems, disclosed herein is new software technology for selecting a set of features that is to be utilized when creating a machine-learning model using a machine-learning process. At a high-level, the disclosed software technology involves (i) constructing a feature graph and (ii) applying a new sampling approach to the feature graph that achieves a more intelligent selection of a subset of features that is to be utilized when creating a machine-learning model using a machine-learning process (as compared to selections of subsets of features achieved using the existing techniques for reducing a set of features) by balancing between (i) diffusion size of features within the feature graph and (ii) diffusion overlap of features within the feature graph relative to any features that were selected for inclusion in the reduced set of features.

In an example, the disclosed software technology functions to: (i) identify an initial set of features; (ii) obtain an input dataset comprising a set of data records that each includes respective values for the initial set of features; (iii) build a feature graph based on the input dataset, wherein the feature graph comprises (a) nodes that represent the features of initial set of features and (b) connections that represent similarities between the features of the initial set of features; (iv) determine a reduced set of features from the initial set of features by selecting features for inclusion in the reduced set of features based on a balancing between (a) diffusion size of features within the feature graph and (b) diffusion overlap of features within the feature graph relative to any features that were selected for inclusion in the reduced set of features; and (v) utilize the reduced set of features in a machine-learning process for training a machine-learning model.

The disclosed software technology could be used to select features for any of various types of machine-learning models, including but not limited to machine-learning models that are trained using any of various types of supervised, semi-supervised, and/or unsupervised learning techniques. For instance, as one possibility, the disclosed software technology could be used to select features for a clustering-based model that is to be trained using one or more unsupervised clustering techniques, examples of which include K-means clustering, hierarchical clustering, affinity propagation (AP) clustering, mean shift clustering, and gaussian mixture model (GMM) clustering. Further, in some implementations, the clustering-based model for which the features are selected may also involve nonlinear dimensionality reduction (also commonly referred to as “manifold learning”), such as a model based on manifold learning techniques using graph embeddings (which may be referred to herein as “clustering-based manifold learning models utilizing graph embeddings methods”). Various clustering-based manifold learning models utilizing graph embeddings methods are possible. For instance, one example of a clustering-based manifold learning model utilizing graph embeddings methods is a clustering-based Uniform Manifold Approximation and Projection (UMAP) model. UMAP models employ nonlinear dimensionality reduction to reduce the dimensions of the output embedding space. A clustering-based UMAP model may create a UMAP embedding space first and then apply clustering to the UMAP embedding space rather than the features themselves. Another example of a clustering-based manifold learning model utilizing graph embeddings methods is a multi-scale representation machine-learning model. Examples of such a multi-scale representation machine-learning model are described in U.S. patent application Ser. No. 18/489,635, which is incorporated herein by reference in its entirety. In an example, such a multi-scale representation machine-learning model may (i) generate a multi-scale representation that represents a feature space defined by a set of data points and (ii) use that multi-scale representation to identify a plurality of clusters associated with the set of data points. Other clustering-based manifold learning models utilizing graph embeddings methods are possible as well.

The disclosed software technology could be used to select features for various other types of machine-learning models as well.

Beneficially, the disclosed software technology helps to identify and select reduced sets of features that are more informative than reduced sets of features identified and selected using existing technology. In this regard, the disclosed software technology may identify a subset of features that carries most of the informational value from the initial set of features and is more representative of the intrinsic structure of the input dataset (compared to reduced sets of features identified using existing techniques). For instance, the disclosed software technology can remove noisy features (e.g., irrelevant, redundant, and/or correlated features) while maintaining features that are representative of the intrinsic structure of the input dataset. In some examples, the disclosed software technology can serve to significantly reduce an initial set of features while still carrying most of the informational value from the features in the initial set. In this regard, the reduced set of features is selected in an intelligent way such that the reduced set still carries most of the informational value from the features in the initial set, which may help to avoid losing much of the predictive value that can otherwise be achieved with the fuller set of features. For instance, in some examples, a universe of features that could potentially have predictive value may be on the order of 1,000 features, and the disclosed software technology can serve to reduce the number of features from on the order of 1,000 features down to a number in the low hundreds or less that are still able to carry most of the informational value from the original features and thereby avoid losing much of the predictive value that can otherwise be achieved with the fuller set of features.

Further, by identifying and selecting reduced sets of features that are more informative, the disclosed software technology beneficially helps to improve performance of machine-learning models that are trained based on sets of features. For instance, machine-learning models that are trained utilizing the reduced sets of features obtaining using the disclosed software technology may achieve improved accuracy as compared to both (i) machine-learning models that are trained utilizing full sets of features and (ii) machine-learning models that are trained utilizing reduced sets of features obtained using the existing technology described above.

Still further, the disclosed software technology beneficially avoids reliance on target variables (which may be unavailable or unreliable) to select features for the reduced set of features. Rather, the disclosed software technology helps to intelligently select features for the reduced set of features without utilizing any target variables, and thus the disclosed software technology is well-suited in scenarios involving machine-learning models that are to be trained using unsupervised learning techniques.

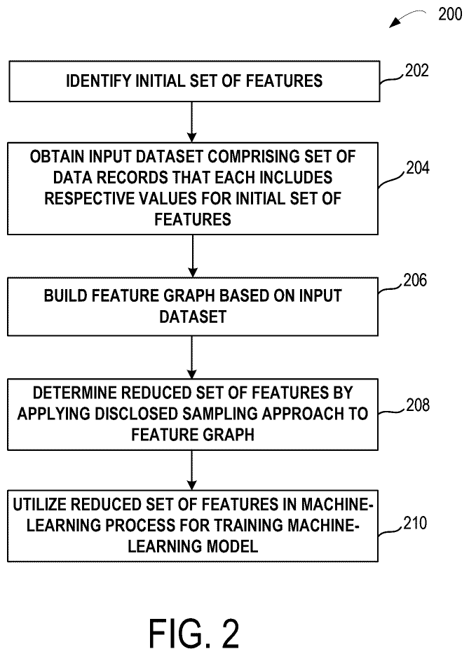

FIG. 2 depicts one example of a process 200 that may be carried out in accordance with the disclosed technology for selecting a set of features to be utilized when creating a machine-learning model using a machine-learning process. For purposes of illustration only, example process 200 is described as being carried out by computing platform 102 of FIG. 1, but it should be understood that example process 200 may be carried out by computing platforms that take other forms as well. Further, it should be understood that, in practice, the functions described with reference to FIG. 2 may be encoded in the form of program instructions that are executable by one or more processors of computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 2, the example process 200 may begin at block 202 with computing platform 102 identifying an initial set of features for a machine-learning model that is to be created for purposes of rendering predictions of a given type. The initial set of features may be any set of features that could potentially have predictive value for the given type of predictions to be made by the machine-learning model, which could take any of various forms depending on the use case. As one example, the given type of prediction may be a prediction related to whether a given transaction was a fraudulent transaction, in which case the initial set of features may comprise any of various features that could potentially have predictive value for predicting whether a transaction is fraudulent. As another example, the given type of prediction may be a prediction related to whether a maintenance and/or repair of the object may be required, in which case the initial set of features may comprise any of various features that could potentially have predictive value for predicting whether a maintenance and/or repair of an object may be required. Many other types of predictions are possible as well. Further, the predictions to be rendered and output by the machine-learning model may take any of various forms, examples of which may include a binary “classification” and/or a likelihood value. The predictions to be rendered and output by the machine-learning model may be of other types and/or forms as well.

Further, the features of the initial set of features may take any of various forms depending on the use case, and may include a large number of features—perhaps numbering on the order of thousands or more.

Further yet, in practice, the initial set of features may be identified based on an analysis of what features are available to the computing platform 102 that may have relevance to the given type of predictions to be rendered by the machine-learning model. For instance, if the given type of predictions to be rendered by the machine-learning model comprises predictions related to financial transactions or individuals (e.g., customers of a data platform operator), then the computing platform 102 may identify all available features that provide information about the financial transactions or individuals—or at least all available features that provide information about the financial transactions or individuals that is expected to be relevant to the given type of the predictions.

The function of identifying the initial set of features may take other forms as well.

At block 204 of FIG. 2, computing platform 102 obtains an input dataset comprising a set of data records that each includes respective values for the initial set of features. The input dataset may take any of various forms. For instance, as one possibility, an input dataset could be represented in the form of a data table or the like in which the rows represent the data records and the columns represent the features. Or as another possibility, the input dataset could be represented in the form of a set of multi-dimensional data points that each comprises an ordered sequence of values for the initial set of features. Further, the input dataset may be obtained from any suitable source. As one example, the input dataset may be obtained from data storage of computing platform 102, such as data storage subsystem 102f. As another example, the input dataset may be obtained from a data source, such as one of the three representative data sources 104a, 104b, and 104c shown in FIG. 1 or another external data source, among other possibilities. Other examples are possible as well.

In practice, the function of obtaining the input dataset may involve computing platform 102 processing and/or transforming source data in order to derive at least some of the respective values for the initial set of features. In this regard, in some examples, source data may not directly include the feature values, and the computing platform 102 the platform may derive the feature values from the source data. The function of obtaining the input data set may take other forms as well.

In one illustrative example, the data records could represent different individual customers of a financial institution and the features could comprise data variables that provide information about the customers. Other example input datasets are possible as well.

At block 206 of FIG. 2, computing platform 102 builds a feature graph based on the obtained input dataset. At a high level, such a feature graph may comprise any graph that represents relationships between features of the input dataset, and in an example, the feature graph may comprise nodes that represent the features and edges (or “connections”) that represent similarities between the features and may have associated numerical values referred to herein as “weights” that quantify the similarities between the features (e.g., on a scale from 0 to 1, where 0 means not similar and 1 means maximum level of similarity).

The function of building the feature graph may take various forms. In one implementation, building the feature graph may involve a two-step process of (i) computing a correlation matrix and then (ii) constructing the feature graph using the correlation matrix. The correlation matrix may be computed in various manners including, for instance, using mutual information correlation or Pearson correlation, among other possibilities.

In a representative example of a two-step process for constructing the feature graph, the feature graph may be denoted as G_{f}=(V_{f}, W_{f}) and the set of features may be denoted as x=(f₁, f₂, . . . , f_{D}), where “D” represents the number of features in the initial set of features (i.e., the number of dimensions within the data records). Given x=(f₁, f₂, . . . , f_{D}), computing platform 102 may compute the correlation matrix W_{f} among the set of features (f₁, f₂, . . . , f_{D}). As discussed above, the correlation matrix W_{f} can be computed in various ways. For instance, computing platform 102 may use Pearson correlation for fi and fj and define the Pearson correlation between the ranks of the variables as:

$${r}_{{f}_{i} , {f}_{j}} = \frac{{\sum }_{u = 1}^{U} ( {f}_{i , u} - {\hat{μ}}_{{f}_{i}} ) ( {f}_{j , u} - {\hat{μ}}_{{f}_{j}} )}{{\hat{σ}}_{{f}_{i}} {\hat{σ}}_{{f}_{j}}} \qquad ( Eq . 1 )$$

where U is the sample size, f_{i,u}, f_{j,u} are two sample points indexed with u, \hat{μ} is the sample mean and \hat{σ} is the sample standard deviation.

After computing the correlation matrix, using the correlation (and optionally normalizing its values to be confined in [0, 1]) as similarities, computing platform 102 may construct a graph G_{{}=(V_{{}, W_{{}) where each feature fᵢ is represented using a node. More particularly, computing platform 102 may construct the graph G_{f}=(V_{f}, W_{f}) using the correlation matrix W_{f}, where the vertices V_{f}, |V_{f}|=D represent the set of D features. Thus, each feature fᵢ is represented by a node in the feature graph G_{f}.

It should be understood that this is one representative example of building the feature graph, and the function of building the feature graph may take other forms as well.

In some examples, the feature graph is a fully connected graph. As used herein, a “fully connected graph” means a graph where each feature is connected to every other feature in the graph (e.g., if there are D features, then every feature is connected to D-1 other features) and the weights are used to quantify how similar the feature is to every other feature (e.g., on a scale from 0 to 1, where 0 means not similar and 1 means maximum level of similarity).

In other examples, the feature graph is a substantially connected graph. As used herein, a “substantially connected graph” means a graph that has a threshold high level of connection between the nodes of the feature graph. For instance, in an example, a substantially connected graph is a graph in which each node is connected to a threshold percentage of other nodes in the feature graph, wherein the threshold percentage could have any of various values (e.g., a value within a range of 75 to 99). Other examples are possible as well.

At block 208 of FIG. 2, computing platform 102 determines a reduced set of features by applying the disclosed sampling approach to the feature graph. At a high-level, diffusion on a graph can be viewed in terms of information propagation across the nodes of the graph, and the disclosed sampling approach involves identifying a subset of nodes from the feature graph in a way that balances between (i) selecting features that have an increased “diffusion size,” which serves as a measure of diffusion area (i.e., the spread of information) provided by a feature within the feature graph, and (ii) selecting features that have a reduced “diffusion overlap” relative to other selected features, which serves as a measure of the overlap between the diffusion area provided by a feature and the diffusion areas provided by other features that have already been selected (i.e., how much of the spread of information provided by the feature is overlapping with and thus cumulative of the spread of information provided by features that have already been selected). In this way, the disclosed sampling approach selects features from the feature graph that not only have larger individual diffusion sizes, but are also more evenly spread out across the feature graph, which results in a reduced set of features that are more informative of the intrinsic structure of the input dataset than a reduced set of features selected using other existing technologies.

Computing platform 102 may quantify the diffusion size and diffusion overlap of the features within the feature graph in any of various ways. For instance, as one possibility, computing platform 102 may determine the spread of information provided by a respective feature within the feature graph by utilizing a localization operator that functions to summarize the local connectivity of the respective feature within the feature graph (e.g., in terms of neighboring features that are within a given number of hops from the respective feature), and may then use the output of the localization operator (which may take the form of a “localization vector” for the respective feature) as a basis for determining a respective feature's diffusion size and diffusion overlap relative to other selected features.

As discussed above, the feature graph may be a fully connected graph where each feature is connected to every other feature in the graph (e.g., if there are D features, then every feature is connected to D-1 other features) and the weights are used to quantify how similar the feature is to every other feature (e.g., on a scale from 0 to 1, where 0 means not similar and 1 means maximum level of similarity). Thus, the feature graph may provide pairwise similarity between all features of the feature graph. The graph location operator can be represented as a matrix when applied to all nodes or as a vector for any individual node. At a high-level, the role of the graph localization operator is to summarize the flow of information within the feature graph. The localization operator may do this by considering not only the direct pairwise similarities between individual nodes (captured by the similarity weights) but also the structure of the graph around each vertex. In other words, the localization operator may reflect patterns determined not only by a node's direct neighbors or strongest connections, but also by its relationships with other nodes across the feature graph and the pattern in which the diffusion process evolves as information spreads out and mixes with surrounding nodes. To summarize, the localization operator leverages the feature graph to capture patterns surrounding each node. These patterns can be quantified by the magnitude of a vector that represents the information flow around a given node.

The localization operator may take any of various forms. As a representative example of a localization operator, the eigenvalues and eigenvectors of W_{f} may be denoted as λ₁^{W}, λ₂^{W} . . . λ_{D}^{W} and φ₁^{W}, . . . φ_{D}^{W}, and computing platform 102 may utilize a localization operator on the center vertex i which is defined as:

$${T}_{g , i} ( n ) = \sqrt{N} {\sum }_{l = 1}^{D} g ( {λ}_{l}^{W} ) ( {ϕ}_{l}^{W} ( i ) ) * {ϕ}_{l}^{W} ( n ) . \qquad ( Eq . 2 )$$

The matrix corresponding to the localization operator in a row is:

$${T}_{g} = [ {T}_{g , 0} , {T}_{g , 1} , … , {T}_{g , D} ] = {Φ}^{W} g ( {Λ}^{W} ) ( {Φ}^{W} ) * . \qquad ( Eq . 3 )$$

It should be understood that this is a representative example of a localization operator, and other localization operators are possible as well.

As noted above, the localization operator may be used as a basis for determining a respective feature's diffusion size and diffusion overlap relative to other selected features. For instance, a respective feature's diffusion size may be determined by (i) applying the localization operator to the respective feature, which produces a respective localization vector for the respective feature, and (ii) calculating the norm of the respective feature's respective localization vector.

Further, a respective feature's diffusion overlap relative to a given other feature may be determined by (i) applying the localization operator to the respective feature as well as the given other feature, which produces respective localization vectors for the respective feature and the given other feature, and (ii) calculating an overlap between the respective localization vectors. In this respect, a respective feature may have its diffusion overlap calculated relative to each of the other features that have previously been selected (if any), and then the diffusion overlap values may be aggregated together (e.g., by taking the sum, the mean, etc. of the diffusion overlap values) to produce the respective feature's diffusion overlap relative to the entire set of selected features.

However, while the foregoing functionality is described in terms of applying the localization operator each time a given feature's localization vector is needed, it should be understood that in practice, each respective feature's localization vector need only be determined once, and then the respective feature's localization vector can thereafter be utilized to determine the diffusion size and diffusion overlap values discussed above.

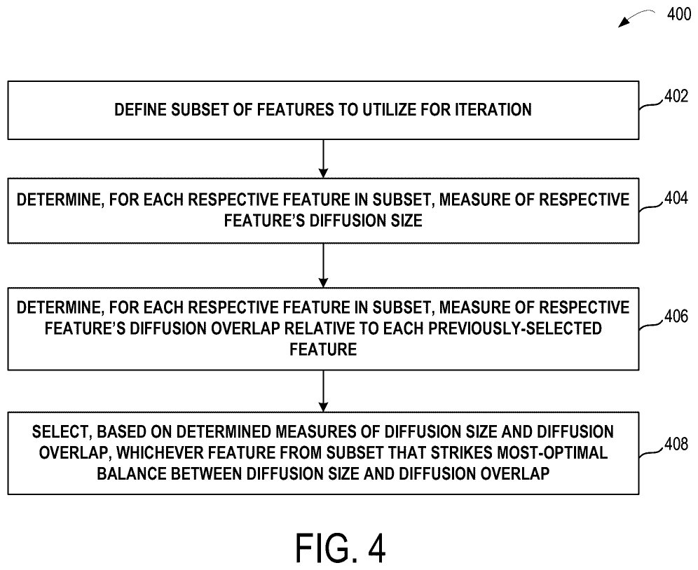

The diffusion size and diffusion overlap metrics may be utilized in a sampling process that iteratively selects features from the feature graph by optimizing an objective function using a greedy technique. In general, the objective function (which may also be referred to as a “cost function”) may be a function that defines an optimal feature to be selected based on each of the other features that have previously been selected. However, in scenarios where the set of features is large (e.g., on the order of hundreds or a thousands of features), solving the objective function requires analyzing all of the features available for selection. Such analysis may require a significant amount of computational resources (e.g., time and/or processing resources), which may not be feasible. Thus, in an example, a greedy technique may be applied, which may help to reduce the computational resources involved in determining the reduced set of features. In general, a greedy technique may follow a problem-solving heuristic of making a locally optimal choice at each stage, and such a technique may help to yield locally optimal solutions that approximate a globally optimal solution in a reasonable amount of time. While applying a greedy technique may result in a sub-optimal selection at each stage, the locally optimal selection achieved by the greedy technique is able to approximate a globally optimal selection. An example objective function and greedy technique are described in further detail below with respect to FIG. 4.

The determination of the localization vectors for the features and the diffusion size and diffusion overlap values described above may take place at various times. For instance, in some implementations, the localization vectors for the features within the feature graph may be pre-computed prior to initiating the sampling process. In other implementations, both the localization vectors for the features and one or both the diffusion size and/or diffusion overlap values may be pre-computed prior to initiating the sampling process. In still other implementations, there will be no pre-computation and the localization vectors and the diffusion size and/or diffusion overlap values will be determined during the iterations on an as-needed basis (although once computed the first time, they can be stored for future use so as to avoid the need to recalculate every time). Other examples of the timing of the determination of the localization vectors for the features and the diffusion size and/or diffusion overlap values described above are possible as well.

As mentioned above, diffusion on a graph can be viewed in terms of information propagation across the nodes of the graph. In this regard, if two nodes are connected by an edge, the information will be transferred between them in proportion to the strength of the connection (e.g., the weight of the edge). Initially, the information is localized at a few nodes, but as the diffusion process captured in the localization operator evolves, information spreads out and mixes with the surrounding nodes. In the context of information propagation, initially clusters of nodes form, where information spreads rapidly, while sparse or small weight connections slow down diffusion between clusters. In the context of the feature graph, the computing platform 102 may be configured to select nodes that propagate information quickly, while also being weakly correlated with other selected nodes. As a particular example, one measure of diffusion size may involve computing the Laplacian matrix of the graph and summing the columns, resulting in a vector of numerical values corresponding to the nodes of the graph. The higher the numerical value in an entry of the vector, the higher the overall diffusion size value of the corresponding node. One can zoom in and examine the diffusion of a particular source node to a particular destination node by examining the entry in the Laplacian matrix corresponding to the source node's row and destination node's column. The higher the numerical value, the higher the diffusion from the source node to the destination node.

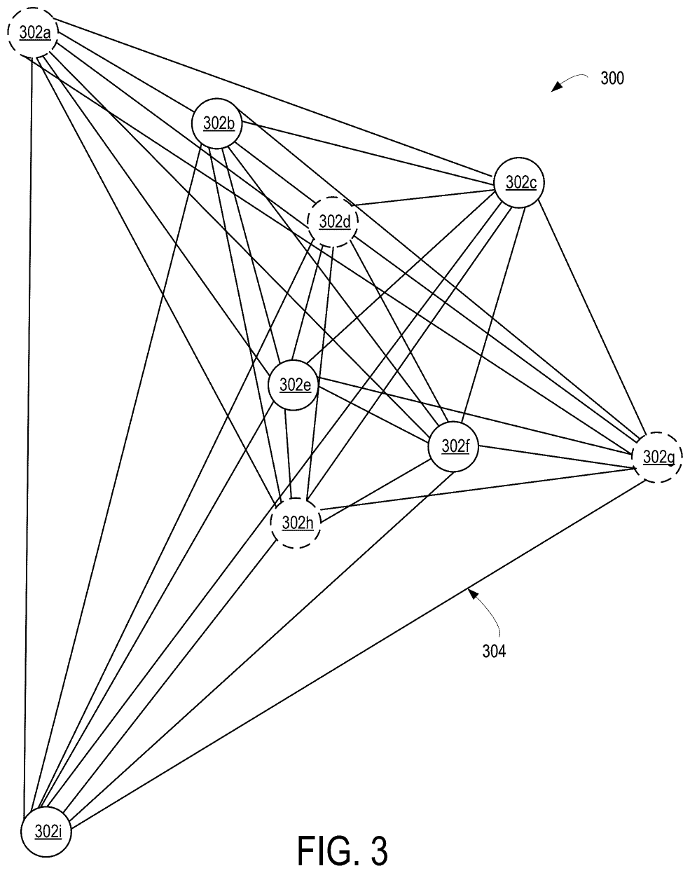

A simplified, illustrative example of a feature graph and selection of a reduced set of features is shown and described with respect to FIG. 3. In particular, feature graph 300 includes nodes 302a-i representing possible features. Further, feature graph 300 includes connections 304 between the nodes 302a-i. The connections 304 between the nodes represent the similarities between the features and may have associated numerical values (i.e., weights) that quantify the similarities between the features.

In this example, the feature graph 300 is a fully connected graph. More particularly, each node has respective connections to every other node in the feature graph. For instance, (i) node 302a has connections to each of nodes 302b-i, (ii) node 302b has connections to each of nodes 302a and 302c-i, (iii) node 302c has connections to each of nodes 302a-b and 302d-i, and so forth. Each node also has a diffusion size which may be determined as described above, and some nodes may have a greater diffusion size compared to other nodes. For instance, as one example, node 302d may have a greater diffusion size compared to node 302i. Further, each node also has a respective diffusion overlap with each of the other nodes within the feature graph 300 which may be determined as described above, and the extent of the respective diffusion overlap may vary based on the structure of the feature graph 300. For instance, node 302d has a lesser extent of diffusion overlap with node 302e than with node 302h.

As discussed above, computing platform 102 may perform the disclosed sampling approach to identify a subset of nodes from the feature graph in a way that balances between (i) selecting features that have an increased “diffusion size” and (ii) selecting features that have a reduced “diffusion overlap” relative to other selected features. In this simplified, illustrative example, the subset of nodes determined using the disclosed sampling approach may be nodes 302a, 302d, 302g, and 302h. These example selected nodes 302a, 302d, 302g, and 302h provide a balance between (i) selecting features that have an increased “diffusion size” and (ii) selecting features that have a reduced “diffusion overlap” relative to other selected features. On the other hand, the other example nodes 302i, 302b-c, and 302e-f may have not been selected for the subset because they did not provide a sufficient combination of increased diffusion size and reduced diffusion overlap relative to other selected nodes. For instance, while node 302i may be more spread out from other nodes (compared to, e.g., node 302e) and may thus have a lesser extent of diffusion overlap relative to other selected nodes, the diffusion size (e.g., the level of local connectivity of node 302i) may be relatively small. In an example, this node 302i may, for instance, correspond to a noisy feature. On the other hand, node 302f may have a relatively large diffusion size, but node 302f may also have a larger extent of diffusion overlap with other selected nodes 302d, 302h, and 302g (and thus may not have been selected for the reduced set of features).

It should be understood that this example of FIG. 3 is a simplified version of a feature graph. In this regard, although in this simplified example the feature graph includes nine nodes, in practice the feature graph may have more nodes (e.g., on the order of tens, hundreds, or thousands, among other possibilities) or fewer nodes (e.g., eight or fewer). Further, it should also be understood that this example of FIG. 3 is a simplified example of a set of features determined using the disclosed sampling approach. The functionality of determining the reduced set of features is described in more detail with reference to FIG. 4.

In particular, one possible implementation of the disclosed sampling process for determining the reduced set of features is described with reference to FIG. 4. In this implementation, computing platform 102 may perform a plurality of iterations of selecting a respective feature to add to the reduced set of features. A flow chart of an example process 400 that may be carried out by computing platform 102 during each iteration of this implementation of the sampling process is described with respect to FIG. 4. For purposes of illustration only, example process 400 is described as being carried out by computing platform 102 of FIG. 1, but it should be understood that example process 400 may be carried out by computing platforms that take other forms as well. Further, it should be understood that, in practice, the functions described with reference to FIG. 4 may be encoded in the form of program instructions that are executable by one or more processors of computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 4, process 400 may begin at block 402 with computing platform 102 defining a subset of the features of the feature graph to utilize for the iteration. The function of defining a subset of the features to utilize for the iteration may take any of various forms. As one possibility, computing platform 102 may randomly select the subset of features from among all the available features of the feature graph that have not been previously selected. Notably, if the current iteration is the first iteration of the sampling process, there will be no other previously-selected features. Other examples of selecting the subset of features are possible as well. Further, the subset of features may include any suitable number of features. In an example, the number of features in the subset may be a number of features corresponding to a predefined percentage of total number of nodes in the feature graph. In another example, the number of features in the subset may be a given number of features, such as 100 or more features, among other possibilities. Other examples are possible as well.

At block 404 of FIG. 4, computing platform 102 determines, for each respective feature in the subset, a measure of the respective feature's diffusion size. In line with the discussion above, in at least some implementations, each respective feature's diffusion size may be quantified in terms of a norm of a localization vector determined for the respective feature using a localization operator that functions to summarize the local connectivity of a feature within the feature graph. In this respect, the function of determining the measure of the respective feature's diffusion size may involve either (i) calculating the respective feature's localization vector as part of the iteration and then determining the diffusion size based thereon, (ii) obtaining the respective feature's localization vector from data storage if the respective feature's localization vector was previously calculated (e.g., during a pre-computation phase or during a prior iteration) and then determining the diffusion size based thereon, or (iii) obtaining the measure of the respective feature's diffusion size from data storage if the measure of the respective feature's diffusion size was previously calculated (e.g., during a pre-computation phase or during a prior iteration).

At block 406 of FIG. 4, computing platform 102 determines, for each respective feature in the subset, a measure of the respective feature's diffusion overlap relative to each previously-selected feature (if any). In line with the discussion above, in at least some implementations, a respective feature's diffusion overlap with a given selected feature may be quantified in terms of an overlap between (i) a localization vector for the respective feature and (ii) a localization vector for the selected feature, where the localization vectors are determined using a localization operator that functions to summarize the local connectivity of a feature within the feature graph. In this respect, the function of determining the measure of the respective feature's diffusion overlap relative to the given selected feature may involve either (i) calculating the localization vectors as part of the iteration and then determining the diffusion overlap based thereon, (ii) obtaining the localization vectors from data storage if they were previously calculated (e.g., during a pre-computation phase or during a prior iteration) and then determining the diffusion overlap based thereon, or (iii) obtaining the measure of the respective feature's diffusion overlap with the given selected feature from data storage if the measure of the respective feature's diffusion overlap with the given selected feature was previously calculated (e.g., during a pre-computation phase or during a prior iteration).

As noted, computing platform 102 determines the diffusion overlap of each respective feature in the subset relative to each previously-selected feature, which means that the number of diffusion overlap values determined for each respective feature in the subset will correspond to the number of previously-selected features (and thus the number of prior iterations that have been carried out). In this respect, if the current iteration is the first iteration of the sampling process, there will be no other previously-selected features and thus this value for the measure of the respective feature's proximity to each previously-selected feature will be zero.

At block 408 of FIG. 4, computing platform 102 selects, based on the determined measures of diffusion size and diffusion overlap, whichever feature from the subset that strikes the most-optimal balance between diffusion size and diffusion overlap. As described above, computing platform 102 may select a feature by optimizing an objective function using a greedy technique, which identifies the feature from the subset that strikes the most-optimal balance between diffusion size and diffusion overlap. In an example, the objective function is:

$$S *= arg {max}_{S ⊂ V} {\sum }_{i ∈ S} 〈 {T}_{g , i} , {T}_{g , i} 〉 - {\sum }_{j ∈ S , j \neq i} 〈 \vert {T}_{g , i} \vert , ⌈ {T}_{g , j} ⌉ 〉 . \qquad ( Eq . 4 )$$

Further, in an example, the greedy algorithm that may be applied to optimize the objective function is:

$$y *= arg {max}_{S ⊂ V} 〈 R ( {ℕ}_{} - {\sum }_{j ∈ {S}_{m}} \vert {T}_{g , j} \vert ) , {T}_{g , y} 〉 \qquad ( Eq . 5 )$$

where Sₘ are vertices that were already selected in the mth iteration, and

$$R ( x ( i ) ) = \{ \begin{matrix}x ( i ) & if x ( i ) \geq 0 \\ 0 & if x ( i ) < 0\end{matrix} \qquad ( Eq . 6 )$$

$$and {T}_{g} = {W}_{f} .$$

The vertex y* is determined using the above-discussed greedy algorithm. This identifies whichever feature from the subset that strikes the most-optimal balance between diffusion size and diffusion overlap. The selected feature can then be added to the reduced set of features.

Computing platform 102 may perform a plurality of these iterations in order to determine the reduced set of features. Computing platform 102 may perform any suitable number of iterations. The number of iterations performed corresponds to the number of nodes selected from the feature graph (where each node represents a feature). Each iteration corresponds to a selection of an additional node that is found to be most important, considering the nodes that were selected so far. The algorithm is greedy; hence the objective function considers the nodes that were selected so far. In an example, the number of iterations may be a number of iterations corresponding to a predefined percentage of total number of nodes in the feature graph. In another example, the number of iterations may be a given number of iterations, such as 50, 75, 100 or more iterations, among other possibilities. Other examples are possible as well.

In an example, computing platform 102 may perform m iterations for the sampling process. Further, in the mth iteration, the vertex y* is (i) determined using the above-discussed greedy algorithm and (ii) added to the reduced set of features. After the mth iteration, the reduced set of features will be the subset Xₘ=x(fₖ_{₁}, fₖ_{₂}, . . . fₖ_{ₘ}).

Further, it should be understood that in some examples, each iteration may have a different subset of features to utilize for the iteration (e.g., a different random subset). Utilizing different random subsets in each iteration may help to ensure that the iterations of the disclosed sampling process involve analyzing a wide range of features of the feature graph.

In some examples, after obtaining a first reduced set of features, computing platform 102 may perform a further refinement of the first reduced set of features. The functionality of the further refinement of the feature selection may take various forms. At a high-level, further refinement may involve: (i) constructing an observation graph using the reduced feature set; (ii) using the observation graph to construct embeddings using an embedding method such as UMAP or a multi-scale representation embedding method; (iii) calculating scores for the features (e.g., Laplacian scores); and (iv) using the calculated Laplacian scores as a basis for deciding whether to re-run the process of block 208 of FIG. 2 to further reduce the set of features.

As a representative example of refinement of the reduced set of features, using the determined reduced subset of features (e.g., subset Xₘ=x(fₖ_{₁}, fₖ_{₂}, . . . fₖ_{ₘ})), computing platform 102 may construct an embedding \tilde{ψ}ₓ using an embedding method. Computing platform 102 may calculate a Laplacian score Lₛ for each feature fₖ_{ᵣ}, where the Laplacian score is calculated with respect to the graph Laplacian L and its associated degree matrix D. After removing the mean from fᵢ, the Laplacian score may be calculated using:

$${L}_{s} ( {f}_{i} ) = \frac{{f}_{i}^{T} L {f}_{i}}{{f}_{i}^{T} D {f}_{i}} . \qquad ( Eq . 7 )$$

Smaller Laplacian scores imply that the feature fᵢ has a larger projection on the subspace of the eigenvectors associated with the smallest eigenvalues, indicating higher importance with respect to the graph structure.

In a similar way, given an embedding of a multi-scale representation embedding method, computing platform 102 may calculate the Laplacian score Lₛ for each feature (\tilde{ψ}ₓ)ₗ where the Laplacian score is calculated with respect to the graph Laplacian L_{\tilde{ψ}}ₓ and its associated degree matrix D_{\tilde{ψ}}ₓ from the regularized feature embedding \tilde{ψ}ₓ as follows: After the mean is removed from (\tilde{ψ}ₓ)ₗ, the Laplacian score may be calculated using:

$${{L}_{s} ( {\tilde{ψ}}_{x} )}_{l} = \frac{{( {\tilde{ψ}}_{x} )}_{l}^{T} {{L}_{{\tilde{ψ}}_{x}} ( {\tilde{ψ}}_{x} )}_{l}}{{( {\tilde{ψ}}_{x} )}_{l}^{T} {{D}_{{\tilde{ψ}}_{x}} ( {\tilde{ψ}}_{x} )}_{l}} . \qquad ( Eq . 8 )$$

Computing platform 102 may then use the calculated Laplacian scores as a basis for deciding whether to re-run the process of block 208 of FIG. 2 to further reduce the set of features, which may in turn result in a second reduced set of features that includes a subset of the first reduced set of features.

Other examples of further refinement are possible as well. Further, in some examples, computing platform 102 may perform multiple iterations of the further refinement process, where each iteration is performed based on the reduced set of features produced by the prior iteration of the further refinement process.

Additionally, in some examples, computing platform 102 may utilize a multi-scale representation machine-learning model that can leverage multi-scale properties to smooth the features. After utilizing a multi-scale representation machine-learning model to smooth the features, a second reduced set of features that includes a subset of the first reduced set of features can be selected based on the refined structure using a Laplacian score.

Returning to FIG. 2, at block 210, computing platform 102 utilizes the resulting reduced set of features in a machine-learning process for training a machine-learning model. In this respect, the machine-learning process may involve functionality for training any of various types of models. As one example, the machine-learning model may be a clustering-based model that is trained using one or more unsupervised learning techniques. As another example, the machine learning-model may be a machine learning-model that is trained using one or more supervised learning techniques. In examples where the machine learning-model is trained using one or more supervised learning techniques, the disclosed feature selection may serve as a pre-processing step to identify the structure of the dataset without introducing bias from the label space utilized by the one or more supervised learning techniques. After the reduced set of features is determined, supervised learning techniques can be applied more effectively. Other types of machine-learning models are possible as well.

Further, the machine-learning models created using a reduced set of features obtained using the disclosed sampling approach may be used in industry for any of various tasks, which may depend at least in part on the type of organization operating the example computing platform 102. For instance, if the example computing platform 102 comprises a data platform operated by a financial institution, a financial institution may utilize the machine-learning model to render and output any of various types of predictions related to the financial institution's business, which may include a prediction of whether a transaction is a fraudulent transaction, a prediction of whether a customer or merchant is engaged in money laundering activities, a prediction of whether a customer committed fraud on a credit card application, or a prediction of whether a prospective or current customer is qualified to receive credit, among various other possibilities. As another example, if the example computing platform 102 comprises a data platform operated by an organization interested in monitoring the state and/or operation of physical objects, the organization may utilize the machine-learning model to render and output any of various types of predictions related to the physical objects, which may include a prediction of whether a maintenance and/or repair of the object may be required, among various other possibilities. As yet another example, an organization may utilize the machine-learning model for determining customer segmentation based on one or more customer attributes. Other examples are possible as well.

Further still, in some examples, the machine-learning model may be retrained based on an updated set of features. For instance, in an example, computing platform 102 may select a first reduced set of features, and utilize the first reduced set of features in a machine-learning process for training a machine-learning model. Computing platform 102 may then (i) further refine the first reduced set of features as described above to determine a second reduced set of features, and (ii) utilize the second reduced set of features in a machine-learning process for retraining the machine-learning model. Other examples of retraining the machine-learning model utilizing updated training data are possible as well.

In the above, the reduced set of features is described as being utilized primarily during the process of creating the machine-learning model. However, it should be understood that after the reduced set of features is utilized during creation of the machine-learning model, the reduced set of features will also form the basis for the features that define the inputs of the machine-learning model during execution.

In some scenarios, there is a minimum set of optimal values in a graph (e.g., a feature graph) such that, if the function that defined the graph is known and the function is band limited, it is possible to reconstruct, based on the values of the sampled nodes, the rest of the signal that is defined over nodes not in the sampling subset for which values are not know. Thus, in some scenarios, it is possible to know a minimum number of sampled nodes that are needed to fully reconstruct the graph. However, in many scenarios, the number of sample nodes needed to fully reconstruct the graph is not known. For instance, when determining the reduced subset of features using the disclosed sampling approach, the best-fit threshold for a number of features that should be included in the reduced set of features may not be known. Thus, in some examples, the disclosed sampling approach may involve hyperparameter tuning to identify a best-fit threshold for a number of features that should be included in the reduced set of features, such that the selected reduced set remains sufficiently informative of the full dataset.

In general, hyperparameter tuning in feature selection may depend on the performance metric(s) of the downstream task(s). For instance, as an example, if the downstream task is a classification task, the hyperparameter tuning may involve tuning the number of features based on the classifier's prediction performance. As another example, in the case of clustering, the hyperparameter tuning can involve selecting the optimal number of features using evaluation metrics such as the Adjusted Rand Index (ARI) or Adjusted Mutual Information (AMI), which are example metrics for assessing the quality of clustering algorithms.

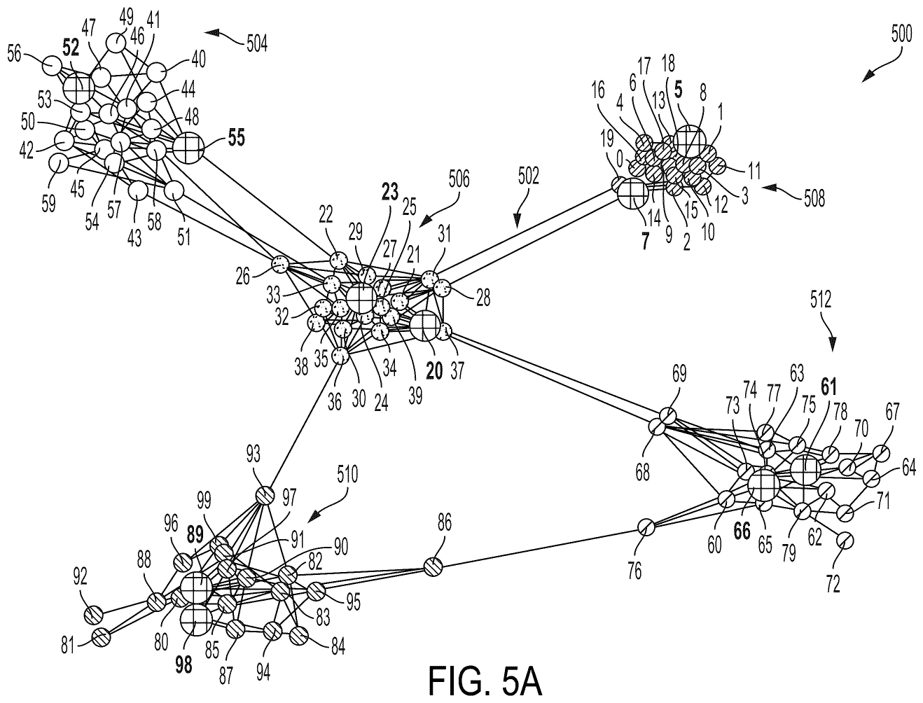

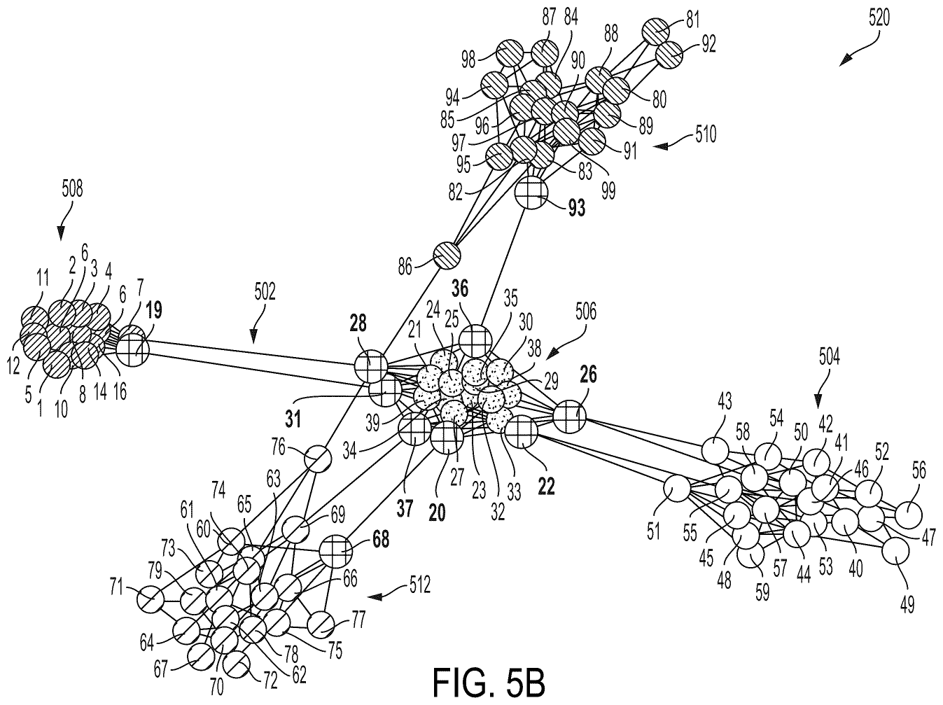

As discussed above, the reduced set of features obtained using the disclosed sampling approach may be a more informative reduced set of features than features selected using existing techniques. A representative example illustrating a more informative reduced set of features obtained using the disclosed sampling approach (compared to a set of features obtained using an existing between-centrality sampling approach) is shown and described with respect to FIGS. 5A-B. In this representative example, features of a feature graph were sampled using (i) the disclosed sampling approach and (ii) a between-centrality sampling approach. The feature graph depicted in the visual representations of FIGS. 5A-B is a synthetic example of a feature graph.

FIG. 5A depicts a visual representation of an example feature graph and an example reduced set of features selected by applying the disclosed sampling approach. In particular, FIG. 5A illustrates a visual representation 500 of a feature graph that includes a plurality of nodes including nodes 0 to 99. Further, the plurality of nodes are arranged in a few dense clusters, and the feature graph has links 502 between and among the nodes. The clusters include cluster 504, cluster 506, cluster 508, cluster 510, and cluster 512. Furthermore, features that were included in the reduced set of features obtained using the disclosed sampling approach are bolded.

FIG. 5B depicts a visual representation of the feature graph of FIG. 5A and an example reduced set of features selected by applying a betweenness-centrality approach. In particular, FIG. 5B illustrates a visual representation 520 of the feature graph depicted in FIG. 5A, where like nodes and clusters in FIGS. 5A-B are labeled with like reference numerals. Similar to FIG. 5A, the plurality of nodes are arranged in a few dense clusters, and the clusters include cluster 504, cluster 506, cluster 508, cluster 510, and cluster 512 (noting, however, that in this visual representation 520 the nodes and clusters are positioned in different locations than in visual representation 500). Furthermore, features that were included in the reduced set of features obtained using a between-centrality sampling approach are bolded.

Notably, the reduced set of features obtained using the disclosed sampling approach includes nodes within all five clusters. On the other hand, the reduced set of features obtained using a between-centrality sampling approach does not include features in all five clusters. While between-centrality measurements are useful in given scenarios and may select important vertices, this illustrative example demonstrates that the between-centrality sampling approach may neglect some clusters and/or other informative nodes. For instance, in this illustrative example, the reduced set of features obtained using a between-centrality sampling approach neglected cluster 504. The between-centrality sampling approach samples features that are associated with edges with high EBC that are located in transition regions between clusters. However, while some of these sampled features may be important features, the method also neglected features in cluster 504. Thus, the reduced set of features is not fully representative of the intrinsic structure of the input dataset.

It should be understood that the feature graph depicted in FIGS. 5A-B is a synthetic example of a feature graph having several clusters and sparse connection between the clusters. While in this synthetic example the ground truth of which cluster each node belongs to may be visually clear, the disclosed sampling approach and the between-centrality sampling approach do not utilize any labels indicating clusters to which the nodes belong. Rather, the disclosed sampling approach and the between-centrality sampling approach select the nodes to sample based on the graph structure. In other words, the reduced set of features obtained using the disclosed sampling approach and the between-centrality sampling approach were obtained without utilizing ground-truth labels indicating clusters to which the nodes belong.

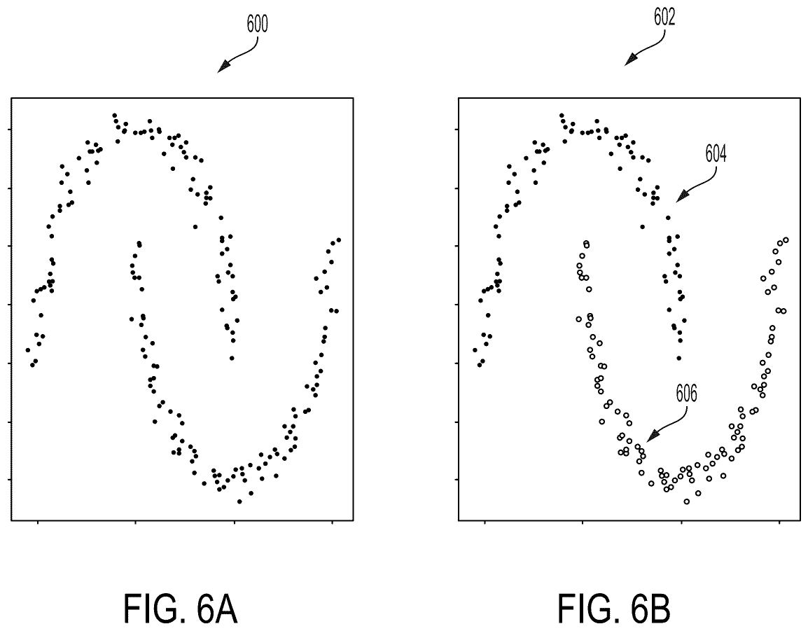

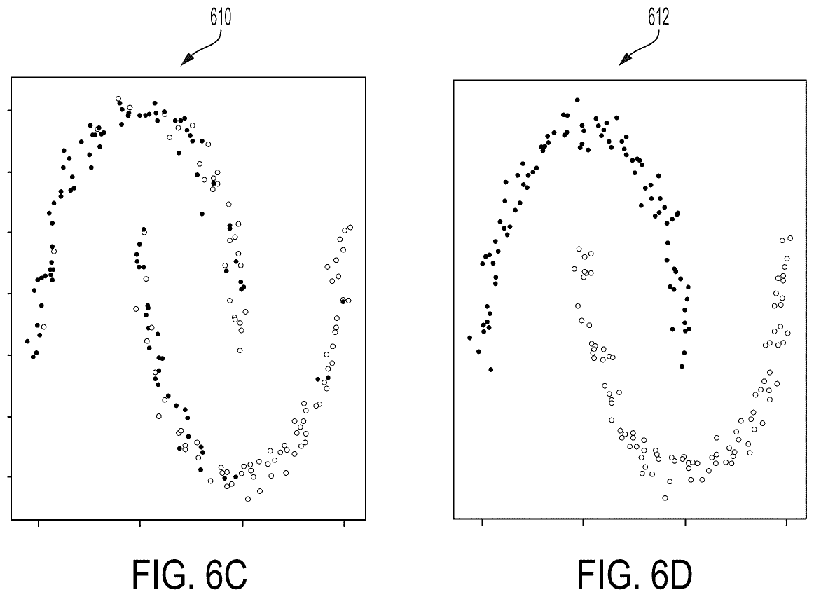

As indicated above, machine-learning models that are trained utilizing the reduced sets of features obtaining using the disclosed sampling approach may achieve improved performance (e.g., compared to machine-learning models that are trained utilizing full sets of features and/or machine-learning models that are trained utilizing reduced sets of features obtaining using existing sampling approaches). A representative example of such improved performance is described with reference to FIGS. 6A-D. In particular, a representative example of improving the quality of clustering via feature selection using the disclosed sampling approach is shown and described with respect to FIGS. 6A-D.

FIG. 6A illustrates a visualization 600 of an example experimental dataset. In particular, this experimental dataset is a two-moons dataset that consists of two clusters (representing intrinsic structure of the dataset) concatenated with additional 8 noisy features. The total number of dimensions of the example experimental dataset is D=10 dimensions. In this example, the first two coordinates f1, f2 were generated by adding a Gaussian noise, with zero mean and variance of 0.1, to a two moon dataset. The noisy features fᵢ, i=3, . . . , D, were drawn from a multivariate Gaussian distribution with zero mean and identity covariance. The total number of samples was N=200, and D=10. Note that in this example the eight (8) noisy features do not carry any information of the two clusters, and the presence of the noisy features obscure discovery of the two clusters by a machine-learning model. Notably, without removing most of the noisy features, nearly any existing clustering-based models (including existing clustering-based manifold learning models utilizing graph embeddings methods) would fail to properly identify the true clusters.

FIG. 6B illustrates a visualization 602 of the dataset of FIG. 6A with ground truth labels 604 and 606. In particular, ground truth label 604 indicates data points corresponding to a first moon of the two-moons dataset, and ground truth label 606 indicates data points corresponding to a second moon of the two-moons dataset. Still further, FIG. 6C illustrates a visualization 610 of example clustering results based on a full set of features, and FIG. 6D illustrates a visualization 612 of example clustering results based on a reduced set of features that were obtained using the disclosed sampling approach.

The effectiveness of the disclosed feature selection method is illustrated in FIG. 6D, which shows the clustering results obtained after applying the disclosed sampling approach to reduce the initial set of features. For the sake of visualization, this figure only shows the first two dimensions which correspond to the two moons features. FIG. 6C shows the clustering results obtained by a clustering-based multi-scale representation machine-learning learning model using the full set of features. As can be seen, the clustering labels contain many errors, and the clustering results are significantly different than the ground truth labels 604 and 606. More particularly, each cluster includes numerous nodes in the first moon and numerous nodes in the second moon.

FIG. 6D shows the clustering results obtained by a clustering-based multi-scale representation machine-learning learning model using only the subset of features determined using the disclosed sampling approach. As can be seen, the clustering results substantially correspond to the ground truth labels 604 and 606.

In this representative example, clustering accuracy was determined on the two moons dataset using both ARI and AMI metrics. Turing first to the ARI metrics, clustering based on k-means achieved an ARI score of 0, clustering based on a multi-scale representation embedding method (with a full dataset) achieved an ARI score of 0.23, and clustering based on multi-scale representation embedding method (with a reduced set of features determine in accordance with the disclosed sampling approach) achieved an ARI score of 1. Turning next to the AMI metrics, clustering based on k-means achieved an AMI score of 0, clustering based on multi-scale representation embedding method (with a full dataset) achieved an AMI score of 0.17, and clustering based on multi-scale representation embedding method (with a reduced set of features determine in accordance with the disclosed sampling approach) achieved an AMI score of 1. Based on these metrics, it is clear that clustering results based on a reduced set of features that were obtained using the disclosed sampling approach were better than clustering results obtained based on a full set of features.

As discussed above, the intrinsic structure of the input dataset refers to the underlying geometric structure and the true relationship among the data points of the input dataset. Further, as discussed above, the underlying geometric structure and the true relationship among the data points of the input dataset may be difficult to discover. For instance, in an example, a simple method using Euclidean measurement between data points may be misleading and wrongly indicate that points belong to a same part of the geometric structure while the points actually belong to a different part of the geometric structure (e.g., a different cluster). In this example experimental dataset associated with FIG. 6A, some points that belong to different clusters are closer in Euclidean distance in comparison to points which belong to the same cluster (thus, this is an illustrative example where the underlying geometric structure and the true relationship among the data points of the input dataset cannot be discovered by simple measurement such as Euclidean distance, though other examples are possible as well). Further, in this example, the clustering results obtained by a clustering-based multi-scale representation machine-learning learning model using the full set of features contained many errors given that the dataset included the eight noisy features that were irrelevant to the underlying geometric structure of the input dataset.

It should be understood that this example of FIGS. 6A-D of improved clustering by a machine-learning model created using a reduced set of features obtained using the disclosed sampling approach is intended as an example only, and other examples of improved performance of machine-learning models that are created using reduced sets of features are possible as well.

While the disclosed sampling approach is primarily described with respect to sampling features of a feature graph, one of ordinary skill in the art should understand that computing platform 102 can utilize similar functionality to sample other types of nodes of other graphs (including but not limited to graphs representing instances rather than features) and (ii) utilize the sampled nodes (e.g., instances) for machine-learning models, such as machine learning models trained using supervised and/or semi-supervised techniques, among other possibilities.

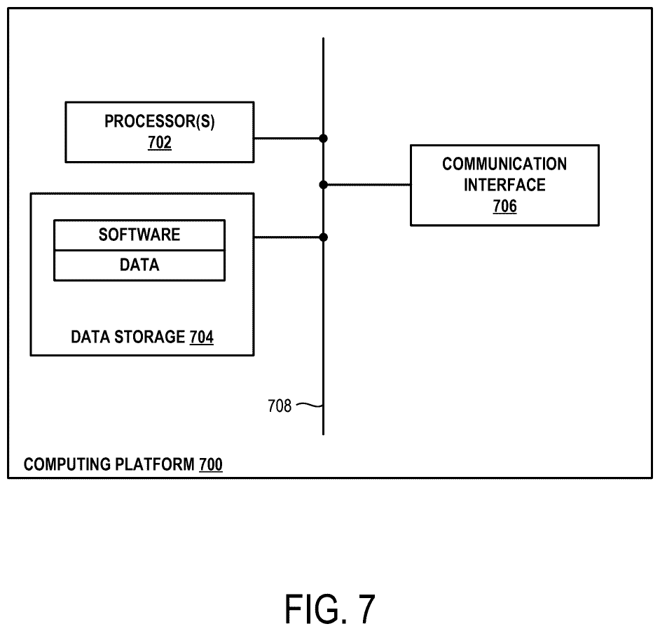

Turning now to FIG. 7, a simplified block diagram is provided to illustrate some structural components that may be included in an example computing platform 700, which may be configured to host and execute the new software technology disclosed herein. As shown in FIG. 7, the example computing platform 700 may include at least a processor 702, data storage 704, and a communication interface 706, all of which may be communicatively linked by a communication link 708 that may take the form of a system bus, a communication network such as a public, private, or hybrid cloud, or some other connection mechanism.

Processor 702 may comprise one or more processing components, such as general-purpose processors (e.g., a single- or multi-core CPU), special-purpose processors (e.g., a GPU, application-specific integrated circuit (ASIC), or digital-signal processor (DSP)), programmable logic devices (e.g., a field programmable gate array), controllers (e.g., microcontrollers), and/or any other processor components now known or later developed. In line with the discussion above, it should also be understood that processor 702 could comprise processing components that are distributed across a plurality of physical computing devices connected via a network, such as a computing cluster of a public, private, or hybrid cloud.

In turn, data storage 704 may comprise one or more non-transitory computer-readable storage mediums that are collectively configured to store (i) program instructions that are executable by processor 702 such that the computing platform 700 is configured to perform any of the various functions disclosed herein (including but not limited to any the functions described above with reference to FIGS. 2 and 4), and (ii) data that may be received, derived, or otherwise stored, for example, in one or more databases, file systems, repositories, or the like, by computing platform 700. In this respect, the one or more non-transitory computer-readable storage mediums of data storage 704 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 704 may comprise computer-readable storage mediums that are distributed across a plurality of physical computing devices connected via a network, such as a storage cluster of a public, private, or hybrid cloud. Data storage 704 may take other forms and/or store data in other manners as well.

Communication interface 706 may be configured to facilitate wireless and/or wired communication with client stations (e.g., one or more consumer systems 106 of FIG. 1) and/or third-party computing platforms. Additionally, in an implementation where the computing platform 700 comprises a plurality of physical computing devices connected via a network, communication interface 706 may be configured to facilitate wireless and/or wired communication between these physical computing devices (e.g., between computing and storage clusters in a cloud network). As such, communication interface 706 may take any suitable form for carrying out these functions, examples of which may include an Ethernet interface, a Wi-Fi network, a cellular network, a serial bus interface (e.g., Firewire, USB 3.0, etc.), a chipset and antenna adapted to facilitate wireless communication, short-range wireless protocols, one or more APIs and/or an API gateway, and/or any other interface that provides for wireless and/or wired communication. Communication interface 706 may also include multiple communication interfaces of different types. Other configurations are possible as well.

Although not shown, the computing platform 700 may additionally include or have an interface for connecting to user-interface components that facilitate user interaction with computing platform 700, such as a keyboard, a mouse, a trackpad, a display screen, a touch-sensitive interface, a stylus, a virtual-reality headset, and/or speakers, among other possibilities.

It should be understood that the computing platform 700 is one example of a computing platform that may be used with the embodiments described herein. Numerous other arrangements are possible and contemplated herein. For instance, in other embodiments, the computing platform 700 may include additional components not pictured and/or more or fewer of the pictured components.

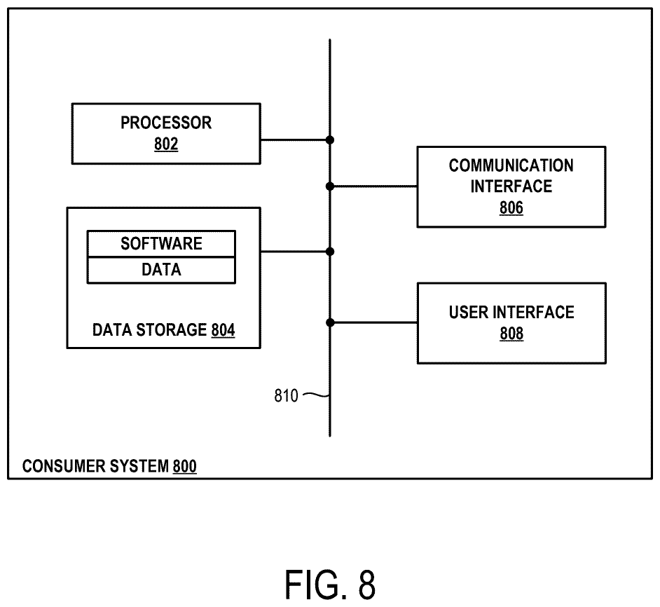

Turning next to FIG. 8, a simplified block diagram is provided to illustrate some structural components that may be included in an example consumer system 800 that may access and communicate with a computing platform that is configured to host and execute the new software technology disclosed herein, such as the computing platform 102 of FIG. 1. As shown in FIG. 8, the consumer system 800 may include at least a processor 802, data storage 804, a communication interface 806, and a user interface 808, all of which may be communicatively linked by a communication link 810 that may take the form of a system bus, a communication network such as a public, private, or hybrid cloud, or some other connection mechanism.

Processor 802 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed. In line with the discussion above, it should also be understood that processor 802 could comprise processing components that are distributed across a plurality of physical computing devices connected via a network, such as a computing cluster of a public, private, or hybrid cloud.

In turn, data storage 804 may comprise one or more non-transitory computer-readable storage mediums that are collectively configured to store (i) program instructions that are executable by processor 802 such that the consumer system 800 is configured to perform certain functions related to interacting with and accessing services provided by a computing platform, and (ii) data that may be received, derived, or otherwise stored, for example, in one or more databases, file systems, repositories, or the like, by the consumer system 800, related to interacting with and accessing services provided by a computing platform. In this respect, the one or more non-transitory computer-readable storage mediums of data storage 804 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 804 may comprise computer-readable storage mediums that are distributed across a plurality of physical computing devices connected via a network, such as a storage cluster of a public, private, or hybrid cloud. Data storage 804 may take other forms and/or store data in other manners as well.

Communication interface 806 may be configured to facilitate wireless and/or wired communication with other computing devices. Communication interface 806 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The consumer system 800 may additionally include a user interface 808 for connecting to one or more user-interface components that facilitate user interaction with the consumer system 800, such as a keyboard, a mouse, a trackpad, a display screen, a touch-sensitive interface, a stylus, a virtual-reality headset, and/or one or more speaker components, among other possibilities.

It should be understood that the consumer system 800 is one example of a consumer system that may be used to interact with an example computing platform as described herein. Numerous other arrangements are possible and contemplated herein. For instance, in other embodiments, the consumer system 800 may include additional components not pictured and/or more or fewer of the pictured components.

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
a communication interface;
at least one processor;
at least one non-transitory computer-readable medium; and
program instructions stored on the at least one non-transitory computer-readable medium that, when executed by the at least one processor, cause the computing platform to:
identify an initial set of features;
obtain an input dataset comprising a set of data records that each includes respective values for the initial set of features;
build a feature graph based on the input dataset, wherein the feature graph comprises (i) nodes that represent the features of initial set of features and (ii) connections that represent similarities between the features of the initial set of features;
determine a reduced set of features from the initial set of features by selecting features for inclusion in the reduced set of features based on a balancing between (i) diffusion size of features within the feature graph and (ii) diffusion overlap of features within the feature graph relative to any features that were selected for inclusion in the reduced set of features; and
utilize the reduced set of features in a machine-learning process for training a machine-learning model.

2. The computing platform of claim 1, wherein selecting features for inclusion in the reduced set of features based on the balancing between (i) diffusion size of features within the feature graph and (ii) diffusion overlap of features within the feature graph relative to any features that were selected for inclusion in the reduced set of features comprises:
performing a plurality of iterations of a sampling process, wherein each iteration comprises:
(i) defining a subset of features from the features of the feature graph to utilize for the iteration;
(ii) obtaining, for each respective feature in the subset, a measure of the respective feature's diffusion size;
(iii) obtaining, for each respective feature in the subset, a measure of the respective feature's diffusion overlap relative to any previously-selected features that were selected for inclusion in the reduced set of features;
(iv) selecting, based on the obtained measures of diffusion size and the obtained measures of diffusion overlap, whichever feature from the subset that strikes a most-optimal balance between diffusion size and diffusion overlap; and
(v) adding the selected feature to the reduced set of features.

3. The computing platform of claim 2, wherein obtaining, for each respective feature in the subset, the measure of the respective feature's diffusion size comprises:
determining the measure of the respective feature's diffusion size by (i) applying a localization operator to the respective feature, which produces a respective localization vector for the feature, and (ii) calculating a norm of the feature's respective localization vector.

4. The computing platform of claim 2, wherein obtaining, for each respective feature in the subset, the measure of the respective feature's diffusion overlap relative to any previously-selected features that were selected for inclusion in the reduced set of features comprises:
for each respective previously-selected feature, determining the measure of the respective feature's diffusion overlap relative to the respective previously-selected feature by (i) applying a localization operator to the respective feature as well as the respective previously-selected feature, which produces respective localization vectors for the respective feature and the respective previously-selected feature, and (ii) calculating an overlap value between the respective localization vectors.

5. The computing platform of claim 2, wherein selecting, based on the obtained measures of diffusion size and the obtained measures of diffusion overlap, whichever feature from the subset that strikes a most-optimal balance between diffusion size and diffusion overlap comprises:
optimizing an objective function using a greedy technique, wherein the objective function defines an optimal feature to be selected based on any previously-selected features that were selected for inclusion in the reduced set of features.

6. The computing platform of claim 2, wherein a number of the plurality of iterations is a predefined percentage of total number of nodes in the feature graph.

7. The computing platform of claim 1, wherein the program instructions stored on the at least one non-transitory computer-readable medium that, when executed by the at least one processor, cause the computing platform to build the feature graph based on the input dataset comprise program instructions stored on the at least one non-transitory computer-readable medium that, when executed by the at least one processor, cause the computing platform to:
compute a correlation matrix based on the input dataset; and
construct the feature graph using the computed correlation matrix.

8. The computing platform of claim 1, wherein the machine-learning model comprises a clustering-based model that is trained using one or more unsupervised learning techniques.

9. A non-transitory computer-readable medium, wherein the non-transitory computer-readable medium is provisioned with program instructions that, when executed by at least one processor, cause a computing platform to:
identify an initial set of features;
obtain an input dataset comprising a set of data records that each includes respective values for the initial set of features;
build a feature graph based on the input dataset, wherein the feature graph comprises (i) nodes that represent the features of initial set of features and (ii) connections that represent similarities between the features of the initial set of features;
determine a reduced set of features from the initial set of features by selecting features for inclusion in the reduced set of features based on a balancing between (i) diffusion size of features within the feature graph and (ii) diffusion overlap of features within the feature graph relative to any features that were selected for inclusion in the reduced set of features; and
utilize the reduced set of features in a machine-learning process for training a machine-learning model.

10. The non-transitory computer-readable medium of claim 9, wherein selecting features for inclusion in the reduced set of features based on the balancing between (i) diffusion size of features within the feature graph and (ii) diffusion overlap of features within the feature graph relative to any features that were selected for inclusion in the reduced set of features comprises:
performing a plurality of iterations of a sampling process, wherein each iteration comprises:
(i) defining a subset of features from the features of the feature graph to utilize for the iteration;
(ii) obtaining, for each respective feature in the subset, a measure of the respective feature's diffusion size;
(iii) obtaining, for each respective feature in the subset, a measure of the respective feature's diffusion overlap relative to any previously-selected features that were selected for inclusion in the reduced set of features;
(iv) selecting, based on the obtained measures of diffusion size and the obtained measures of diffusion overlap, whichever feature from the subset that strikes a most-optimal balance between diffusion size and diffusion overlap; and
(v) adding the selected feature to the reduced set of features.

11. The non-transitory computer-readable medium of claim 10, wherein obtaining, for each respective feature in the subset, the measure of the respective feature's diffusion size comprises:
determining the measure of the respective feature's diffusion size by (i) applying a localization operator to the respective feature, which produces a respective localization vector for the feature, and (ii) calculating a norm of the feature's respective localization vector.

12. The non-transitory computer-readable medium of claim 10, wherein obtaining, for each respective feature in the subset, the measure of the respective feature's diffusion overlap relative to any previously-selected features that were selected for inclusion in the reduced set of features comprises:
for each respective previously-selected feature, determining the measure of the respective feature's diffusion overlap relative to the respective previously-selected feature by (i) applying a localization operator to the respective feature as well as the respective previously-selected feature, which produces respective localization vectors for the respective feature and the respective previously-selected feature, and (ii) calculating an overlap value between the respective localization vectors.

13. The non-transitory computer-readable medium of claim 10, wherein selecting, based on the obtained measures of diffusion size and the obtained measures of diffusion overlap, whichever feature from the subset that strikes a most-optimal balance between diffusion size and diffusion overlap comprises:
optimizing an objective function using a greedy technique, wherein the objective function defines an optimal feature to be selected based on any previously-selected features that were selected for inclusion in the reduced set of features.

14. The non-transitory computer-readable medium of claim 10, wherein a number of the plurality of iterations is a predefined percentage of total number of nodes in the feature graph.

15. The non-transitory computer-readable medium of claim 9, wherein the program instructions that, when executed by the at least one processor, cause the computing platform to build the feature graph based on the input dataset comprise program instructions that, when executed by at least one processor, cause the computing platform to:
compute a correlation matrix based on the input dataset; and
construct the feature graph using the computed correlation matrix.

16. The non-transitory computer-readable medium of claim 9, wherein the machine-learning model comprises a clustering-based model that is trained using one or more unsupervised learning techniques.

17. A method carried out by a computing platform, the method comprising:
identifying an initial set of features;
obtaining an input dataset comprising a set of data records that each includes respective values for the initial set of features;
building a feature graph based on the input dataset, wherein the feature graph comprises (i) nodes that represent the features of initial set of features and (ii) connections that represent similarities between the features of the initial set of features;
determining a reduced set of features from the initial set of features by selecting features for inclusion in the reduced set of features based on a balancing between (i) diffusion size of features within the feature graph and (ii) diffusion overlap of features within the feature graph relative to any features that were selected for inclusion in the reduced set of features; and
utilizing the reduced set of features in a machine-learning process for training a machine-learning model.

18. The method of claim 17, wherein selecting features for inclusion in the reduced set of features based on the balancing between (i) diffusion size of features within the feature graph and (ii) diffusion overlap of features within the feature graph relative to any features that were selected for inclusion in the reduced set of features comprises:
performing a plurality of iterations of a sampling process, wherein each iteration comprises:
(i) defining a subset of features from the features of the feature graph to utilize for the iteration;
(ii) obtaining, for each respective feature in the subset, a measure of the respective feature's diffusion size;
(iii) obtaining, for each respective feature in the subset, a measure of the respective feature's diffusion overlap relative to any previously-selected features that were selected for inclusion in the reduced set of features;
(iv) selecting, based on the obtained measures of diffusion size and the obtained measures of diffusion overlap, whichever feature from the subset that strikes a most-optimal balance between diffusion size and diffusion overlap; and
(v) adding the selected feature to the reduced set of features.

19. The method of claim 18, wherein obtaining, for each respective feature in the subset, the measure of the respective feature's diffusion size comprises:
determining the measure of the respective feature's diffusion size by (i) applying a localization operator to the respective feature, which produces a respective localization vector for the feature, and (ii) calculating a norm of the feature's respective localization vector.

20. The method of claim 18, wherein obtaining, for each respective feature in the subset, the measure of the respective feature's diffusion overlap relative to any previously-selected features that were selected for inclusion in the reduced set of features comprises:
for each respective previously-selected feature, determining the measure of the respective feature's diffusion overlap relative to the respective previously-selected feature by (i) applying a localization operator to the respective feature as well as the respective previously-selected feature, which produces respective localization vectors for the respective feature and the respective previously-selected feature, and (ii) calculating an overlap value between the respective localization vectors.
